(19) United States
(12) Patent Application Publication
(10) Pub. No.: US 2023/0087818 A1
(43) Pub. Date: Mar. 23, 2023

(54) TIRE

(71) Applicant: Sumitomo Rubber Industries, Ltd., Kobe-shi (JP)

(72) Inventors: Akikazu SHIMIZU, Kobe-shi (JP); Oliver KNISPEL, Kobe-shi (JP)

(73) Assignee: Sumitomo Rubber Industries, Ltd., Kobe-shi (JP)

(21) Appl. No.: 17/948,253

(22) Filed: Sep. 20, 2022

(30) Foreign Application Priority Data
Sep. 21, 2021 (JP) 2021-153475

(51) Int. Cl. B60C 11/13; B60C 11/03

(52) U.S. Cl. CPC B60C 11/13; B60C 11/0304; B60C 2011/0365

(57) ABSTRACT

The tire can have a tread portion. The tread portion can include a first shoulder circumferential groove and a first shoulder land portion. In the first shoulder land portion, a plurality of first shoulder lateral grooves can be disposed. At least one of the first shoulder lateral grooves can include an inner end connected to the first shoulder circumferential groove, a maximum groove width portion, and an outer portion. The maximum groove width portion can be at almost the center, in a tire axial direction, of a ground contact surface of the first shoulder land portion. A groove width at the inner end and a groove width, on a first tread end, of the first shoulder lateral groove can each be less than the maximum groove width. A groove width of the outer portion can be reduced outward in the tire axial direction.

### CROSS-REFERENCE TO RELATED APPLICATION(S)

The present application claims priority to Japanese Patent App. No. 2021-153475 filed Sep. 21, 2021, wherein the entire content and disclosure of which is incorporated herein by reference.

### BACKGROUND

### Field

The present disclosure relates to a tire.

### Background Art

Japanese Laid-Open Patent Publication No. 2013-139166 suggests a pneumatic tire that includes a plurality of outer shoulder lateral grooves extending across an outer shoulder land portion. In such pneumatic tire, the outer shoulder lateral grooves are expected to enhance drainage performance and on-snow performance.

In recent years, tires have been required to have further enhanced wet performance. Meanwhile, the enhancement of wet performance should not impair steering stability on dry road surfaces.

### SUMMARY

The present disclosure is directed to a tire including a tread portion. The tread portion includes a plurality of circumferential grooves disposed between a first tread end and a second tread end so as to continuously extend in a tire circumferential direction, and a plurality of land portions demarcated by the plurality of circumferential grooves. The plurality of circumferential grooves include a first shoulder circumferential groove disposed closest to the first tread end. The plurality of land portions include a first shoulder land portion demarcated by the first shoulder circumferential groove, the first shoulder land portion including the first tread end. The first shoulder land portion includes a plurality of first shoulder lateral grooves extending from the first shoulder circumferential groove to a position beyond the first tread end. At least one of the first shoulder lateral grooves includes an inner end connected to the first shoulder circumferential groove, a maximum groove width portion at which the first shoulder lateral groove has a maximum groove width in a ground-contact surface of the first shoulder land portion, and an outer portion disposed outward of the first tread end in a tire axial direction. A groove width at the inner end and a groove width, on the first tread end, of the first shoulder lateral groove are each less than the maximum groove width. A groove width of the outer portion is reduced outward in the tire axial direction.

### BRIEF DESCRIPTION OF THE DRAWINGS

FIG. 1 is a development of a tread portion according to one or more embodiments of the present disclosure;

FIG. 2 is an enlarged view of a first shoulder land portion in FIG. 1;

FIG. 3 is an enlarged view of a first shoulder lateral groove in FIG. 2;

FIG. 4 is a cross-sectional view taken along a line A-A in FIG. 2;

FIG. 5 is an enlarged view of a second shoulder land portion in FIG. 1;

FIG. 6 is an enlarged view of a first middle land portion, a second middle land portion, and a crown land portion in FIG. 1;

FIG. 7 is a cross-sectional view taken along a line B-B in FIG. 6; and

FIG. 8 is a development of a tread portion of a tire of a comparative example.

### DETAILED DESCRIPTION

The present disclosure has been made in view of the aforementioned circumstances in the background section, and an object of the present disclosure, among multiple objects, can be to provide a tire having enhanced wet performance while maintaining steering stability on dry road surfaces.

The tire of the present disclosure has the above-described configuration and can thus have enhanced wet performance while maintaining steering stability on dry road surfaces.

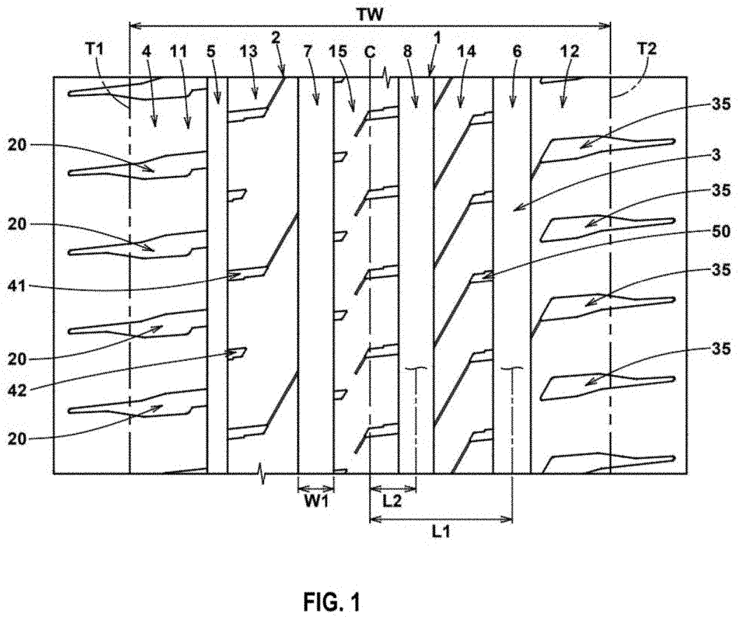

An embodiment of the present disclosure will be described below with reference to the drawings. FIG. 1 is a development of a tread portion 2 of a tire 1 according to one or ore embodiments of the present disclosure. The tire 1 may be used as, for example, a pneumatic tire for a passenger car. However, the present disclosure is not limited thereto, and may be applied to a heavy-duty pneumatic tire or a non-pneumatic tire the inside of which is not filled with pressurized air, as other examples.

As shown in FIG. 1, the tread portion 2 can include a plurality of circumferential grooves 3 disposed between a first tread end T1 and a second tread end T2 so as to continuously extend in a tire circumferential direction, and a plurality of land portions 4 demarcated by the plurality of circumferential grooves 3. The tire 1 can be configured as a so-called five-rib tire in which the tread portion 2 includes five land portions 4 demarcated by four circumferential grooves 3. However, the present disclosure is not limited thereto.

For example, the tread portion 2 can have a designated mounting direction to a vehicle. Thus, the first tread end T1 can be disposed on the outer side of a vehicle when the tire is mounted to the vehicle. The second tread end T2 can be disposed on the inner side of the vehicle when the tire is mounted to the vehicle. The mounting direction to a vehicle can be, for example, indicated by a character or symbol on a sidewall portion. The tire 1 according to embodiments of the present disclosure is not limited thereto, and a mounting direction to a vehicle may not necessarily be designated.

The first tread end T1 and the second tread end T2 can each correspond to an outermost ground contact portion in the tire axial direction, for instance, when 70% of a normal load is applied to the tire 1 in a normal state, and the tire 1 is in contact with a plane at a camber angle of 0°, for instance.

The “normal state” can represent a state in which the tire is mounted on a normal rim and is inflated to a normal internal pressure and no load is applied to the tire for pneumatic tires for which various standards are defined. For non-pneumatic tires and tires for which various standards are not defined, the normal state can represent a standard use state, corresponding to a purpose of use of the tire, in which the tire is not mounted to a vehicle and no load is applied to the tire. In the description herein, unless otherwise specified, dimensions and the like of components of the tire are represented by values measured in the normal state.

The “normal rim” can represent a rim that is defined by a standard, in a standard system including the standard on which the tire is based, for each tire, and is, for example, “standard rim” in the JATMA standard, “Design Rim” in the TRA standard, or “Measuring Rim” in the ETRTO standard.

The “normal internal pressure” can represent an air pressure that is defined by a standard, in a standard system including the standard on which the tire is based, for each tire, and is “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard.

The “normal load” can represent a load that is defined by a standard, in a standard system including the standard on which the tire is based, for each tire, and is “maximum load capacity” in the JATMA standard, the maximum value recited in the table “TIRE LOAD LIMITS AT VARIOUS COLD INFLATION PRESSURES” in the TRA standard, or “LOAD CAPACITY” in the ETRTO standard, for pneumatic tires for which various standards are defined. For non-pneumatic tires and tires for which various standards are not defined, the “normal load” represents a load that acts on one tire in a standard mounting state of the tire. The “standard mounting state” can represent a state in which a tire is mounted to a standard vehicle corresponding to the purpose of use of the tire and the vehicle is stationary on a flat road surface in a state where the vehicle can run.

The plurality of circumferential grooves 3 can include a first shoulder circumferential groove 5 disposed closest to the first tread end T1. Furthermore, the plurality of circumferential grooves 3 can include a second shoulder circumferential groove 6, a first crown circumferential groove 7, and a second crown circumferential groove 8. The second shoulder circumferential groove 6 can be disposed closest to the second tread end T2. The first crown circumferential groove 7 can be disposed between the first shoulder circumferential groove 5 and a tire equator C. The second crown circumferential groove 8 can be disposed between the second shoulder circumferential groove 6 and the tire equator C.

A distance L1 in the tire axial direction from the tire equator C to a groove center line of the first shoulder circumferential groove 5 or the second shoulder circumferential groove 6 can be, for example, 25% to 35% of a tread width TW. A distance L2 in the tire axial direction from the tire equator C to a groove center line of the first crown circumferential groove 7 or the second crown circumferential groove 8 can be, for example, 5% to 15% of the tread width TW. The tread width TW can refer to or be characterized as a distance in the tire axial direction from the first tread end T1 to the second tread end T2 in the normal state.

For example, each circumferential groove 3 can linearly extend in parallel to the tire circumferential direction. Each circumferential groove 3 may extend, for example, in a wavy manner.

Each circumferential groove 3 can have a groove width W1 of at least 3 mm. The groove width W1 of each circumferential groove 3 can be, for example, 4.0% to 8.5% of the tread width TW. In the description herein, the groove width can refer or be characterized as to a distance between two edges of the groove in the normal state. The two edges can refer to or be characterized as boundaries, between the opening of the groove and the ground-contact surface, formed, for instance, when 70% of the normal load is applied to the tire 1 in the normal state, and the outer surface of the tread portion 2 is in contact with a plane at a camber angle of 0°, for instance.

In the present embodiment, the first shoulder circumferential groove 5 can have the smallest groove width among the plurality of circumferential grooves 3. However, the present disclosure is not limited thereto. Each circumferential groove 3 can have a depth of, for example, 5 to 10 mm in the case of a pneumatic tire for a passenger car.

The plurality of land portions 4 according to one or more embodiments of the present disclosure can include a first shoulder land portion 11. The first shoulder land portion 11 can include the first tread end T1, and can be demarcated so as to be disposed outward of the first shoulder circumferential groove 5 in the tire axial direction.

The land portions 4 according to one or more embodiments of the present disclosure can include a second shoulder land portion 12, a first middle land portion 13, a second middle land portion 14, and a crown land portion 15. The second shoulder land portion 12 can include the second tread end T2, and can be demarcated so as to be disposed outward of the second shoulder circumferential groove 6 in the tire axial direction. The first middle land portion 13 can be demarcated between the first shoulder circumferential groove 5 and the first crown circumferential groove 7. The second middle land portion 14 can be demarcated between the second shoulder circumferential groove 6 and the second crown circumferential groove 8. The crown land portion 15 can be demarcated between the first crown circumferential groove 7 and the second crown circumferential groove 8.

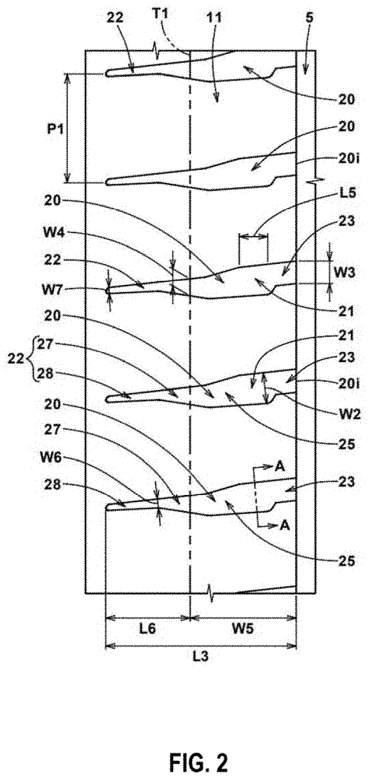

FIG. 2 is an enlarged view of the first shoulder land portion 11. As shown in FIG. 2, a plurality of first shoulder lateral grooves 20 can be disposed in the first shoulder land portion 11. The first shoulder lateral groove 20 can extend from the first shoulder circumferential groove 5 to a position beyond the first tread end T1.

At least one of the first shoulder lateral grooves 20 can include an inner end 20i connected to the first shoulder circumferential groove 5, a maximum groove width portion 21 at which the first shoulder lateral groove 20 has a maximum groove width W2 in the ground-contact surface of the first shoulder land portion 11, and an outer portion 22 disposed outward of the first tread end T1 in the tire axial direction. The maximum groove width portion 21 can include, in addition to a portion at which the first shoulder lateral groove 20 has the maximum groove width W2, a portion at which the first shoulder lateral groove 20 has a groove width of not less than 95% of the maximum groove width W2.

A groove width W3 at the inner end 20i of the first shoulder lateral groove 20, and a groove width W4, on the first tread end T1, of the first shoulder lateral groove 20, can each be less than the maximum groove width W2. In addition, the groove width of the outer portion 22 of the first shoulder lateral groove 20 can be reduced outward in the tire axial direction. In the present disclosure, for one or more embodiments of the disclosed subject matter, by adopting the above-described configuration, wet performance can be enhanced while steering stability on dry road surfaces (hereinafter, may be simply referred to as “steering stability”) can be maintained.

According to one or more embodiments of the present disclosure, the maximum groove width portion 21, of the first shoulder lateral groove 20, disposed in the ground-contact surface of the first shoulder land portion 11 can exhibit excellent drainage performance, to enhance wet performance.

In addition, according to one or more embodiments of the present disclosure, the groove width W3 at the inner end 20i of the first shoulder lateral groove 20, and the groove width W4 on the first tread end T1, can be less than the maximum groove width W2. Therefore, even when a ground contact pressure acts on the first shoulder land portion 11, the first shoulder lateral groove 20 can be unlikely to be opened, and the pattern stiffness of the first shoulder land portion 11 can be maintained. Therefore, steering stability on dry road surfaces can be effectively maintained.

Furthermore, according to one or more embodiments the present disclosure, the groove width of the outer portion 22 of the first shoulder lateral groove 20 can be reduced outward in the tire axial direction. Therefore, a region of the first shoulder land portion 11 disposed outward of the first tread end T1 can have a high stiffness. Thus, for example, on the outer side of the tire during cornering, when increase of a ground contact pressure moves the ground contact end outward in the tire axial direction, the tire can come into contact with the ground in a region having a high stiffness, and the steering stability can be more assuredly maintained. It can be understood that the above-described mechanism can allow the tire according to one or more embodiments the present disclosure to have enhanced wet performance while maintaining steering stability on dry road surfaces.

The structure of one or more embodiments of the present disclosure will be described below in more detail. The structures described below can represent specific modes of one or more embodiments of the disclosed subject matter. Therefore, needless to say, also when the structures described below are not provided, the technique of one or more embodiments of the present disclosure can exhibit the above-described effects. Also when any one of the structures described below is applied alone to the tire of one or more embodiments of the present disclosure having the above-described features, improvement of performance corresponding to each structure can be expected. Furthermore, in a case where some of the structures described below are applied in combination, complex performance improvement corresponding to the structures can be expected.

In the first shoulder land portion 11, the plurality of First shoulder lateral grooves 20 can be disposed, and no other grooves or recesses can be disposed. According to one or more embodiments of the present disclosure, the plurality of first shoulder lateral grooves 20 can have substantially the same shape. One pitch length P1 in the tire circumferential direction between two first shoulder lateral grooves 20 adjacent to each other in the tire circumferential direction can be, for example, 100% to 120% of a width W5, in the tire axial direction, of the ground-contact surface of the first shoulder land portion 11. However, embodiments of the present disclosure is not limited thereto. The one pitch length can represent a distance in the tire circumferential direction between the groove center lines of two first shoulder lateral grooves 20 adjacent to each other in the tire circumferential direction. In a case where the distance in the tire circumferential direction varies in the tire axial direction, the center value can be adopted.

The groove width W3 of the inner end 20i of the first shoulder lateral groove 20 can be, for example, 50% to 90%, such as 70% to 80% of the maximum groove width W2. The first shoulder lateral groove 20 which can include the inner end 20i having such a structure can contribute to well-balanced enhancement of steering stability and wet performance.

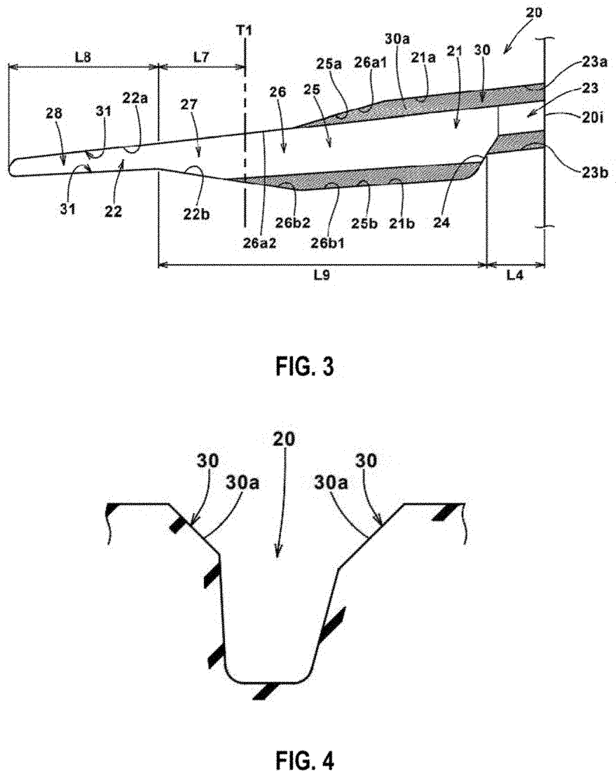

FIG. 3 is an enlarged view of the first shoulder lateral groove 20. As shown in FIG. 3, the first shoulder lateral groove 20 can include, for example, an inner portion 23 that can extend outward from the inner end 20i in the tire axial direction with a uniform groove width. A length L4, in the tire axial direction, of the inner portion 23 can be, for example, 10% to 30%, such as 15% to 25% of the width W5 (shown in FIG. 2, the same applies to the following description) of the ground-contact surface of the first shoulder land portion 11. The inner portion 23 having such a structure can contribute to well-balanced enhancement of steering stability and wet performance. In the description herein, the structure such as the length of the groove can be measured and defined at the groove center line.

The first shoulder lateral groove 20 can include, for example, a body portion 25 between the inner portion 23 and the outer portion 22. The body portion 25 can include the maximum groove width portion 21 described above. According to one or more embodiments of the present disclosure, the maximum groove width portion 21 can be connected so as to be disposed outward of the inner portion 23 in the tire axial direction. Specifically, an edge 23a on one side (upper side in FIG. 3), in the tire circumferential direction, of the inner portion 23, and an edge 21a on the one side, in the tire circumferential direction, of the maximum groove width portion 21 can be linearly connected directly to each other. An edge 23b on the other side (lower side in FIG. 3), in the tire circumferential direction, of the inner portion 23, and an edge 21b on the other side, in the tire circumferential direction, of the maximum groove width portion 21 can be connected through a circumferential edge 24 extending at an angle of 20 to 40° with respect to the tire circumferential direction. Thus, the groove width of the first shoulder lateral groove 20 can increase stepwise in the inner portion 23 and the maximum groove width portion 21.

The developers have found as a result of various experiments that drainage (groove volume) at almost the center, in the tire axial direction, of the ground-contact surface of the first shoulder land portion 11 can make a contribution to the drainage performance of the first shoulder lateral groove 20. Therefore, according to one or more embodiments of the disclosed subject matter, the maximum groove width portion 21 can be disposed at almost the center, in the tire axial direction, of the ground-contact surface of the first shoulder land portion 11. Thus, the maximum groove width portion 21 can more effectively exhibit drainage. This configuration can include at least an embodiment in which the maximum groove width portion 21 extends across the center position, in the tire axial direction, of the ground-contact surface of the first shoulder land portion 11. The configuration can also include an embodiment in which, even when the maximum groove width portion 21 does not extend across the center position, a distance between the maximum groove width portion 21 and the center position may not be greater than 5% of the width W5, for instance, in the tire axial direction, of the ground-contact surface of the first shoulder land portion 11.

As shown in FIG. 2, the maximum groove width W2 can be, for example, 20% to 35% of the one pitch length P1 for the first shoulder lateral groove 20. A length L5, in the tire axial direction, of the maximum groove width portion 21 can be, for example, 25% to 45%, such as 30% to 40% of the width W5, in the tire axial direction, of the ground-contact surface of the first shoulder land portion 11. The first shoulder lateral groove 20 that includes the maximum groove width portion 21 having such a structure can exhibit excellent wet performance while maintaining steering stability.

As shown in FIG. 3, the body portion 25 can include, for example, a groove width reduction portion 26 having a groove width reduced from the maximum groove width portion 21 toward the first tread end T1. An edge on the one side, in the tire circumferential direction, of the groove width reduction portion 26 can include a portion 26a1 that is connected to the edge 21a of the maximum groove width portion 21 and can extend at an angle greater than that of the edge of the maximum groove width portion 21 with respect to the tire axial direction, and a portion 26a2 that can extend to the first tread end T1 at the same angle as that of the edge of the maximum groove width portion 21 with respect to the tire axial direction. An edge on the other side, in the tire circumferential direction, of the groove width reduction portion 26 can include a portion 26b1 that can be linearly connected directly to the edge of the maximum groove width portion 21, and a portion 26b2 that can extend to the first tread end T1 at an angle greater than that of the edge 21b of the maximum groove width portion 21 with respect to the tire axial direction. In the groove width reduction portion 26 having such a structure, turbulent flow may be unlikely to occur when water moves in the groove, and the groove width in the vicinity of the first tread end T1 can be reduced while the drainage of the first shoulder lateral groove 20 is maintained.

As shown in FIG. 2, the groove width W4, at the first tread end T1, of the first shoulder lateral groove 20 can be, for example, 45% to 70%, such as 50% to 65% of the maximum groove width W2. The first shoulder lateral groove 20 having such a structure can also reduce pitch sound that occurs during running on a dry road surface while exhibiting the above-described effects.

For example, according to one or more embodiments, the groove width of the outer portion 22 can be continuously reduced outward from the first tread end T1 in the tire axial direction. Thus, uneven wear around the outer portion 22 can be reduced. However, embodiments of the present disclosure are not limited thereto, and the outer portion 22 may include, for example, a portion extending with a uniform groove width.

The outer portion 22 can include, for example, a first portion 27 on the first tread end T1 side, and a second portion 28 disposed outward of the first portion 27 in the tire axial direction. The groove width of the first portion 27 can be reduced outward in the tire axial direction at a first reduction rate. The groove width of the second portion 28 can be reduced outward in the tire axial direction at a second reduction rate less than the first reduction rate. The outer portion 22 having such a structure can provide excellent steering stability even in a high load applied state in which a high load acts on the tread portion. The high load applied state can mean that, as in the front wheel during braking or the outer wheel during cornering, a higher load acts on the tread portion than during normal running, and the outer portion 22 (particularly, the second portion 28) is in contact with the ground.

The first and second reduction rates can each be defined as a ratio of the maximum groove width of the corresponding portion relative to the smallest groove width of the portion. The first reduction rate of the first portion 27 can be, for example, 200% to 300%. The second reduction rate of the second portion 28 can be, for example, 130% to 200%. The angle between the two edges of the first portion 27 can be, for example, 10 to 25°. The angle between the two edges of the second portion 28 can be less than that of the first portion 27, and may be, for example, less than 10°.

A length L6, in the tire axial direction, of the outer portion 22 can be, for example, not greater than the width W5, in the tire axial direction, of the ground-contact surface of the first shoulder land portion 11. For example, the length L6 can be 70% to 90%, such as 75% to 85% of the width W5. As shown in FIG. 3, a length L7, in the tire axial direction, of the first portion 27 can be, for instance, 20% to 50% of the length L6, in the tire axial direction, of the outer portion 22. A length L8, in the tire axial direction, of the second portion 28 can be, for instance, 50% to 80% of the length L6 (shown in FIG. 2, the same applies to the following description), in the tire axial direction, of the outer portion 22. The outer portion 22 having such a structure can allow well-balanced enhancement of wet performance and steering stability in the high load applied state.

From the viewpoint of sufficiently enhancing steering stability in the high load applied state, the length L8 of the second portion 28 can be, for example, greater than the length L4, in the tire axial direction, of the inner portion 23. In addition, from the viewpoint of ensuring sufficient lengths of the first portion 27 and the body portion 25, the length L8 of the second portion 28 can be, for example, less than a length L9, in the tire axial direction, of a portion of the first shoulder lateral groove 20 excluding the second portion 28 and the inner portion 23.

As shown in FIG. 2, a groove width W6 at a boundary between the first portion 27 and the second portion 28 can be, for example, 25% to 35% of the maximum groove width W2. A groove width W7 at an outer end, in the tire axial direction, of the first shoulder lateral groove 20 can be, for example, 10% to 30%, such as 15% to 25% of the maximum groove width W2. The groove width at the outer end can represent a groove width at ends, in the tire axial direction, of two edges extending along a groove length direction.

The first shoulder lateral groove 20 can have, for example, the maximum depth at the body portion 25. The maximum depth of the first shoulder lateral groove 20 can be, for example, 60% to 90%, such as 70% to 80% of the maximum depth of the first shoulder circumferential groove 5.

The inner portion 23 can have a depth less than that of the body portion 25. The maximum depth of the inner portion 23 can have, for example, 45% to 65%, such as 50% to 60% of the maximum depth of the first shoulder lateral groove 20.

For example, the depth of the outer portion 22 can be reduced outward in the tire axial direction. The depth at the outer end of the first shoulder lateral groove 20 can be, for example, 5% to 25%, such as 10% to 20% of the maximum depth of the first shoulder lateral groove 20. The outer portion 22 having such a structure can contribute to well-balanced enhancement of steering stability and wet performance.

FIG. 4 is a cross-sectional view taken along a line A-A of the first shoulder lateral groove 20 in FIG. 2. As shown in FIG. 4, a chamfered portion 30 can be, for example, connected to at least a portion of the edge of the first shoulder lateral groove 20. The chamfered portion 30 can include an inclined surface 30a extending diagonally from the edge. The inclined surface 30a can extend so as to be inclined between the ground-contact surface of the first shoulder land portion 11 and a groove wall of the first shoulder lateral groove 20. The angle of the inclined surface 30a with respect to the tire radial direction can be, for example, 30 to 60°. For example, the inclined surface 30a can have a width of not greater than 2 mm and such as from 0.5 to 1.5 mm (inclusive), in the tread planar view. For example, the inclined surface 30a can have a depth of not greater than 2 mm, such as 0.5 to 1.5 mm. The chamfered portion 30 having such a structure can contribute to reduction of uneven wear of the first shoulder land portion 11. Also in a case where the chamfered portion is connected to the edge of the groove, the groove width of the groove in the description herein can represent a distance between the two edges of the groove in the normal state. As described above, the two edges can refer to or be characterized as boundaries, between the opening of the groove and the ground-contact surface, formed, for instance, when 70% of the normal load is applied to the tire 1 in the normal state, and the outer surface of the tread portion 2 is in contact with a plane at a camber angle of 0°, for instance.

In FIG. 3, dots are formed on the inclined surface 30a of the chamfered portion 30. As shown in FIG. 3, according to one or more embodiments of the present disclosure, an edge (edge on the upper side in FIG. 3) on the one side, in the tire circumferential direction, of the first shoulder lateral groove 20 and an edge (edge on the lower side in FIG. 3) on the other side, in the tire circumferential direction, of the first shoulder lateral groove 20 can each have both a region to which the chamfered portion 30 is connected and a region to which the chamfered portion 30 is not connected (hereinafter, such a region is referred to as a non-chamfered portion 31). The non-chamfered portion 31 can refer to a portion in which the ground-contact surface of the first shoulder land portion 11 is connected to the groove wall of the first shoulder lateral groove 20 to form an angular portion having an almost right angle.

The chamfered portion 30 connected to the edge on the one side can extend from the inner end 20i of the first shoulder lateral groove 20 to a position preceding the first tread end T1. That is, on the first tread end T1, the edge on the one side can be formed as the non-chamfered portion 31. A distance between an end of the chamfered portion 30 and the first tread end T1 can be, for example, 3 to 15 mm, such as 5 to 10 mm. The edge on the one side can linearly extend from the inner end 20i to the maximum groove width portion 21 in the first shoulder lateral groove 20. The chamfered portion 30 connected to the edge on the one side can extend from the inner end 20i to the maximum groove width portion 21 in the first shoulder lateral groove 20 with a uniform width. Thus, uneven wear of the first shoulder land portion 11 can be reduced.

The chamfered portion 30 connected to the edge on the other side can be disposed at least in the inner portion 23 and the maximum groove width portion 21 of the first shoulder lateral groove 20. According to one or more embodiments of the present disclosure, the chamfered portion 30 connected to the edge on the other side can extend from the maximum groove width portion 21 to a position beyond the first tread end T1. That is, on the first tread end T1, the chamfered portion 30 can be connected to the edge on the other side. A distance from an end, in the tire axial direction, of the chamfered portion 30 connected to the edge on the other side to the first tread end T1 can be, for example, not greater than 5 mm.

As described above, according to one or more embodiments of the present disclosure, on the first tread end T1, the edge on the one side of the first shoulder lateral groove 20 can be formed as the non-chamfered portion 31, and the chamfered portion 30 can be connected to the edge on the other side of the first shoulder lateral groove 20. Such an arrangement of the chamfered portion 30 can reduce uneven wear in the vicinity of the first tread end T1 in the first shoulder lateral groove 20 while ensuring frictional force due to the edge in the vicinity of the first tread end T1.

The inner portion 23 and the maximum groove width portion 21 of the first shoulder lateral groove 20 can be structured such that the chamfered portions 30 are connected to the edges on both sides except for the circumferential edge 24. An edge 22a on the one side, in the tire circumferential direction, of the outer portion 22 can be entirely formed as the non-chamfered portion 31. The chamfered portion 30 can be connected merely to an end portion, on the first tread end T1 side, of an edge 22b on the other side, in the tire circumferential direction, of the outer portion 22, and the other portion of the edge 22b can be formed as the non-chamfered portion 31. Therefore, at least in the second portion 28, the edges on both sides can each be formed as the non-chamfered portion 31. Thus, uneven wear of the first shoulder land portion 11 can be reduced, and, when the outer portion 22 is in contact with the ground, the non-chamfered portion 31 can provide a high frictional force.

From a similar viewpoint, the chamfered portion 30 can be connected to an edge 25a on the one side, in the tire circumferential direction, of the body portion 25 in a portion connected to the maximum groove width portion 21, and an end portion of the edge 25a on the first tread end T1 side can be formed as the non-chamfered portion 31. The chamfered portion 30 can be connected to the entirety of an edge 25b on the other side, in the tire circumferential direction, of the body portion 25.

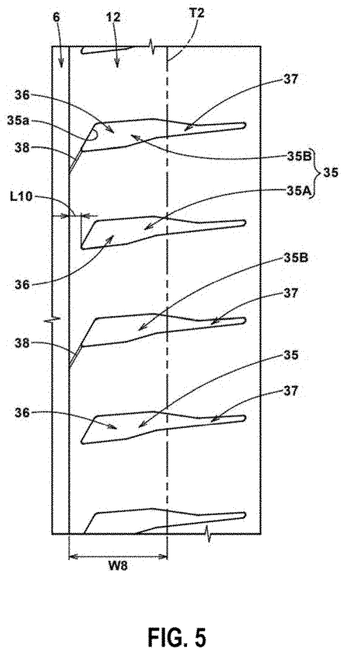

FIG. 5 is an enlarged view of the second shoulder land portion 12. As shown in FIG. 5, a plurality of second shoulder lateral grooves 35 can be disposed in the second shoulder land portion 12. The second shoulder lateral groove 35 of one or more embodiments of the present disclosure can include, for example, a body portion 36 extending from a position away from the second shoulder circumferential groove 6 to the second tread end T2, and an outer portion 37 disposed outward of the second tread end T2 in the tire axial direction. The above-described configuration of the outer portion 22 (shown in FIGS. 2 and 3) of the first shoulder lateral groove 20 can be applied to the outer portion 37 of the second shoulder lateral groove 35. The configuration of the body portion 25 of the first shoulder lateral groove 20, excluding a configuration described below, can be applied to the body portion 36 of the second shoulder lateral groove 35.

A distance L10 in the tire axial direction from the body portion 36 of the second shoulder lateral groove 35 to the second shoulder circumferential groove 6 can be, for example, 5% to 15% of a width W8, in the tire axial direction, of the ground-contact surface of the second shoulder land portion 12. The second shoulder lateral groove 35 that includes the body portion 36 having such a structure can enhance wet performance while maintaining stiffness of the second shoulder land portion 12.

The body portion 36 of the second shoulder lateral groove 35 can include, at an inner end thereof in the tire axial direction, an inclined edge 35a that extends in the tire circumferential direction so as to be inclined. An angle of the inclined edge 35a with respect to the tire circumferential direction can be, for example, 20 to 40°. The inclined edge 35a having such a structure can provide a frictional force in the tire axial direction, and can enhance cornering performance on wet road surfaces.

The second shoulder lateral groove 35 of one or more embodiments of the present disclosure can include a standard second shoulder lateral groove 35A and a shallow-groove-equipped second shoulder lateral groove 35B. According to one or more embodiments of the present disclosure, the standard second shoulder lateral grooves 35A and the shallow-groove-equipped second shoulder lateral grooves 35B can alternate in the tire circumferential direction.

According to one or more embodiments of the disclosed subject matter, standard second shoulder lateral groove 35A may not have a groove between the body portion 36 and the second shoulder circumferential groove 6. The shallow-groove-equipped second shoulder lateral groove 35B can include a shallow groove portion 38 that extends from the body portion 36 to the second shoulder circumferential groove 6. The shallow groove portion 38 can have a groove width and depth of, for example, 0.3 to 1.5 mm, such as 0.5 to 1.0 mm. The shallow groove portion 38 having such a structure can supplement a frictional force in the tire axial direction on wet road surfaces.

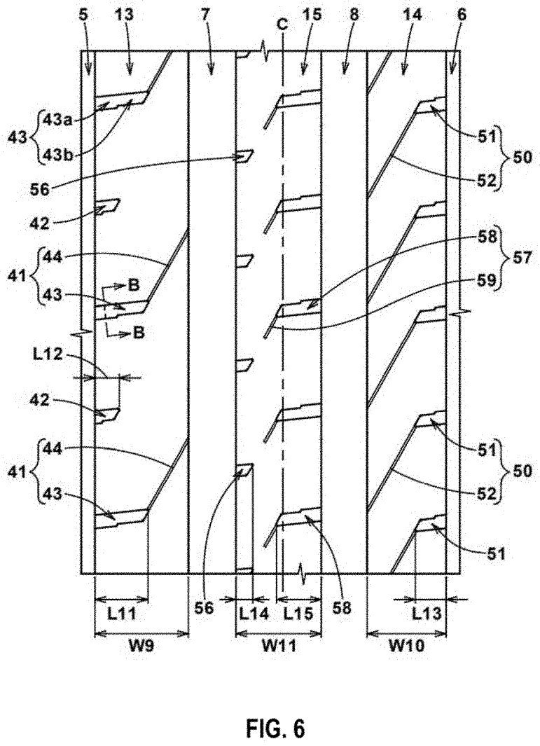

FIG. 6 is an enlarged view of the first middle land portion 13, the second middle land portion 14, and the crown land portion 15. As shown in FIG. 6, in the first middle land portion 13, a plurality of first middle lateral grooves 41 and a plurality of first middle terminating grooves 42 can be disposed. The first middle lateral grooves 41 and the first middle terminating grooves 42 may alternate in the tire circumferential direction.

The first middle lateral groove 41 can include, for example, a body portion 43 that extends from the first shoulder circumferential groove 5 in the tire axial direction, and a shallow groove portion 44 that extends from the body portion 43 to the first crown circumferential groove 7.

The body portion 43 can be, for example, connected to the first shoulder circumferential groove 5 at a position different from the inner portion 23 of the first shoulder lateral groove 20 in the tire circumferential direction. Thus, superposition of pitch sounds by the lateral grooves and uneven wear of the land portions can be reduced.

The body portion 43 of the first middle lateral groove 41 can be, for example, disposed at an angle of not greater than 100 with respect to the tire axial direction. A length L11, in the tire axial direction, of the body portion 43 can be, for example, 40% to 60% of a width W9, in the tire axial direction, of the ground-contact surface of the first middle land portion 13. According to one or more embodiments of the disclosed subject matter, the length L11, in the tire axial direction, of the body portion 43 of the first middle lateral groove 41 can be greater than a length, in the tire axial direction, of the inner portion 23 (shown in FIG. 2) of the first shoulder lateral groove 20, and can be less than the length, in the tire axial direction, of the body portion 25 (shown in FIG. 2) of the first shoulder lateral groove 20. The first middle lateral groove 41 that includes the body portion 43 having such a structure can contribute to well-balanced enhancement of steering stability and wet performance.

The maximum groove width of the body portion 43 can be, for example, less than the maximum groove width W2 (shown in FIG. 2) of the first shoulder lateral groove 20, and optionally less than the groove width W3 (shown in FIG. 2) at the inner end 20i of the first shoulder lateral groove 20. The maximum groove width of the body portion 43 can be 35% to 50% of the maximum groove width W2 of the first shoulder lateral groove 20. The first middle lateral groove 41 that includes the body portion 43 having such a structure can enhance steering stability and wet performance in cooperation with the first shoulder lateral groove 20.

The body portion 43 can include, for example, a wide width portion 43a that is connected to the first shoulder circumferential groove 5, and a narrow width portion 43b that has a groove width less than that of the wide width portion 43a. A groove width of the narrow width portion 43b can be 60% to 90%, for instance, of the groove width of the wide width portion 43a.

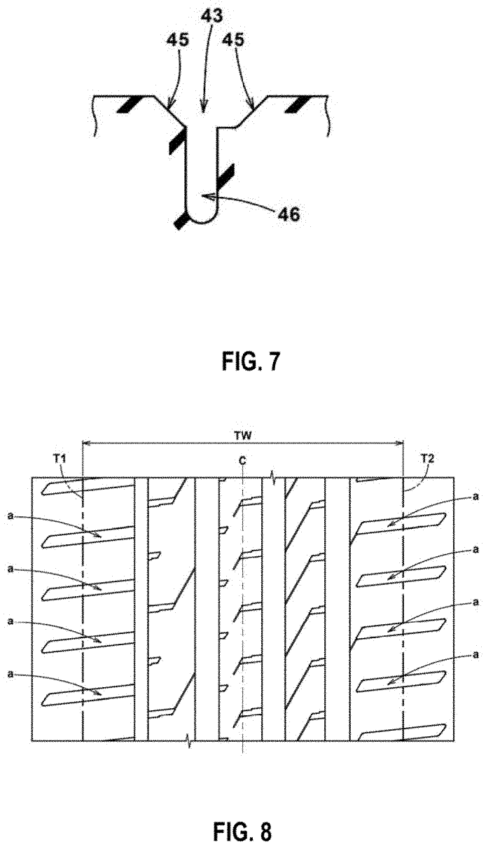

FIG. 7 is a cross-sectional view taken along a line B-B in FIG. 6. As shown in FIG. 7, a chamfered portion 45 can be connected to an edge of the body portion 43 of the first middle lateral groove 41. A narrow groove portion 46 having a width of 0.5 to 1.5 mm, for instance, can be connected and disposed inward of the chamfered portions 45 in the tire radial direction. A depth of the body portion 43 including the depths of the chamfered portion 45 and the narrow groove portion 46 can be, for example, 40% to 60% of the maximum depth of the first shoulder circumferential groove 5. The first middle lateral groove 41 that includes the body portion 43 having such a structure can maintain stiffness of the first middle land portion 13 and enhance steering stability.

As shown in FIG. 6, a groove width and depth of the shallow groove portion 44 of the first middle lateral groove 41 can be, for example, 0.3 to 1.5 mm, such as 0.5 to 1.0 mm. The shallow groove portion 44 can be, for example, disposed at an angle greater than that of the body portion 43 with respect to the tire axial direction. The angle of the shallow groove portion 44 with respect to the tire axial direction can be, for example, 50 to 70°. The shallow groove portion 44 having such a structure can provide, with its edge, a frictional force in the tire axial direction, and can enhance cornering performance on wet road surfaces.

For example, the first middle terminating groove 42 can extend from the first shoulder circumferential groove 5 and can terminate in the first middle land portion 13. A length L12, in the tire axial direction, of the first middle terminating groove 42 can be, for example, less than the length, in the tire axial direction, of the body portion 43 of the first middle lateral groove 41. For instance, the length L12 of the first middle terminating groove 42 can be, for instance, 20% to 30% of the width W9, in the tire axial direction, of the ground-contact surface of the first middle land portion 13. The first middle terminating groove 42 having such a structure can enhance wet performance while maintaining stiffness of the first middle land portion 13.

The first middle terminating groove 42 can have substantially the same transverse cross-section as the transverse cross-section, such as shown in FIG. 7, of the body portion 43 of the first middle lateral groove 41. Therefore, the configuration of the transverse cross-section of the first middle lateral groove 41 can be applied to the transverse cross-section of the first middle terminating groove 42.

As shown in FIG. 6, in the second middle land portion 14, a plurality of second middle lateral grooves 50 can be disposed. The second middle lateral groove 50 can include a body portion 51 that can extend from the second shoulder circumferential groove 6, and a shallow groove portion 52 that can extend from the body portion 51 to the second crown circumferential groove 8. The above-described configurations of the body portion 43 and the shallow groove portion 44 of the first middle lateral groove 41, excluding configurations described below, can be applied to the body portion 51 and the shallow groove portion 52 of the second middle lateral groove 50.

For example, the body portion 51 of the second middle lateral groove 50 can terminate without extending across the center position, in the tire axial direction, of the ground-contact surface of the second middle land portion 14. A length L13, in the tire axial direction, of the body portion 51 of the second middle lateral groove 50 can be, for instance, 30% to 50% of a width W10, in the tire axial direction, of the ground-contact surface of the second middle land portion 14. According to one or more embodiments, the length L13, in the tire axial direction, of the body portion 51 of the second middle lateral groove 50 can be less than the length L11, in the tire axial direction, of the body portion 43 of the first middle lateral groove 41. The second middle lateral groove 50 that includes the body portion 51 having such a structure can enhance wet performance while appropriately maintaining stiffness of the second middle land portion 14.

In the crown land portion 15, a plurality of first crown lateral grooves 56 and a plurality of second crown lateral grooves 57 can be disposed.

The first crown lateral groove 56 can extend from the first crown circumferential groove 7 and can terminate in the crown land portion 15 without reaching the second crown circumferential groove 8. A length L14, in the tire axial direction, of the first crown lateral groove 56 can be, for example, 10% to 30% of a width W11, in the tire axial direction, of the ground-contact surface of the crown land portion 15. According to one or more embodiments of the disclosed subject matter, the length L14 of the first crown lateral groove 56 can be less than each of the length L11, in the tire axial direction, of the body portion 43 of the first middle lateral groove 41, the length L12, in the tire axial direction, of the first middle terminating groove 42, and the length L13, in the tire axial direction, of, the body portion 51 of the second middle lateral groove 50. The first crown lateral groove 56 having such a structure can assuredly maintain stiffness of the crown land portion 15 and can enhance steering stability while supplementing wet performance.

The second crown lateral groove 57 can include, for example, a body portion 58 that can extend from the second crown circumferential groove 8 in the tire axial direction, and a shallow groove portion 59 that can extend from the body portion 58 and can terminate without reaching the first crown circumferential groove 7.

The body portion 58 of the second crown lateral groove 57 can extend from the second crown circumferential groove 8 and can terminate in the crown land portion 15 without reaching the first crown circumferential groove 7. A length L15, in the tire axial direction, of the body portion 58 of the second crown lateral groove 57 can be, for example, 45% to 60% of the width W11, in the tire axial direction, of the ground-contact surface of the crown land portion 15. According to one or more embodiments of the disclosed subject matter, the length L15 of the body portion 58 of the second crown lateral groove 57 can be less than the length L11, in the tire axial direction, of the body portion 43 of the first middle lateral groove 41, and can be greater than the length L13, in the tire axial direction, of the body portion 51 of the second middle lateral groove 50. The second crown lateral groove 57 that includes the body portion 58 having such a structure can contribute to well-balanced enhancement of steering stability and wet performance.

The shallow groove portion 59 of the second crown lateral groove 57 can have a groove width and depth of, for example, 0.3 to 1.5 mm, such as 0.5 to 1.0 mm. For example, the shallow groove portion 59 of the second crown lateral groove 57 can extend at an angle greater than that of the body portion 58 with respect to the tire axial direction. The shallow groove portion 59 of the second crown lateral groove 57 can be inclined in the same direction as the direction in which the shallow groove portion 44 of the first middle lateral groove 41 is inclined. The angle of the shallow groove portion 59 of the second crown lateral groove 57 with respect to the tire axial direction can be, for example, 50 to 70°. The second crown lateral groove 57 that includes the shallow groove portion 59 having such a structure can contribute to enhancement of cornering performance during running on wet road surfaces.

Although the tire according to embodiments of the present disclosure has been described above in detail, the present disclosure is not limited to the above-described specific embodiments, and various modifications can be made to implement the technique of the present disclosure.

### Examples

Tires having a size of 225/50R17 and the basic pattern shown in FIG. 1 were produced as test tires according to the specifications indicated in Tables 1 to 3. In addition, as a comparative example, a tire having a tread portion shown in FIG. 8 was produced as a test tire. Each shoulder lateral groove a of the tire of the comparative example extended in the tire axial direction with a uniform groove width. The tire of the comparative example was substantially the same as the tire shown in FIG. 1, except for the above-described structure. For each test tire, steering stability and wet performance were tested. Specifications common to the test tires and test methods were as follows.

Rim on which the tire was mounted: 17×7.5 J

Tire internal pressure: 220 kPa for front wheel, 240 kPa for rear wheel

Test vehicle: a rear wheel drive vehicle having an engine displacement of 2000 cc

Tire mounting positions: all wheels

<Steering Stability>

Sensory evaluation was made by a driver for steering stability when the test vehicle was caused to run on a dry road surface. The results are indicated as scores with the score of the steering stability of the comparative example being 100. The greater the value is, the more excellent the steering stability is.

<Wet Performance>

Sensory evaluation was made by a driver for wet performance when the test vehicle was caused to run on a wet road surface. The results are indicated as scores with the score of the wet performance of the comparative example being 100. The greater the value is, the more excellent the wet performance is.

The test results are indicated in Tables 1 to 3.

TABLE 1

| | Comparative | Example | Example | Example | Example | Example | Example | Example | Example | Example |
|---|---|---|---|---|---|---|---|---|---|---|
| | example | 1 | 2 | 3 | 4 | 5 | 6 | 7 | 8 | 9 |
| FIGURE showing tread | FIG. 8 | FIG. 1 | FIG. 1 | FIG. 1 | FIG. 1 | FIG. 1 | FIG. 1 | FIG. 1 | FIG. 1 | FIG. 1 |
| pattern | | | | | | | | | | |
| Groove width W3 at inner | 100 | 75 | 50 | 70 | 80 | 90 | 75 | 75 | 75 | 75 |
| end/maximum groove | | | | | | | | | | |
| width W2 (%) in first | | | | | | | | | | |
| shoulder lateral groove | | | | | | | | | | |
| Groove width W4 at first | 100 | 58 | 58 | 58 | 58 | 58 | 45 | 50 | 65 | 70 |
| tread end/maximum | | | | | | | | | | |
| groove width W2 (%) in | | | | | | | | | | |
| first shoulder lateral | | | | | | | | | | |
| groove | | | | | | | | | | |
| Groove width W7 at outer | 100 | 20 | 20 | 20 | 20 | 20 | 20 | 20 | 20 | 20 |
| end/maximum groove | | | | | | | | | | |
| width W2 (%) in first | | | | | | | | | | |
| shoulder lateral groove | | | | | | | | | | |
| Length L4 of inner | — | 20 | 20 | 20 | 20 | 20 | 20 | 20 | 20 | 20 |
| portion/width W5 of first | | | | | | | | | | |
| shoulder land portion (%) | | | | | | | | | | |
| Length L6 of outer | 80 | 80 | 80 | 80 | 80 | 80 | 80 | 80 | 80 | 80 |
| portion/width W5 of first | | | | | | | | | | |
| shoulder land portion (%) | | | | | | | | | | |
| Steering stability (score) | 100 | 107 | 108 | 107 | 106 | 104 | 107 | 107 | 106 | 105 |
| Wet performance (score) | 100 | 105 | 102 | 104 | 105 | 105 | 103 | 104 | 106 | 106 |

TABLE 2

| | Example | Example | Example | Example | Example | Example | Example | Example |
|---|---|---|---|---|---|---|---|---|
| | 10 | 11 | 12 | 13 | 14 | 15 | 16 | 17 |
| FIGURE showing tread | FIG. 1 | FIG. 1 | FIG. 1 | FIG. 1 | FIG. 1 | FIG. 1 | FIG. 1 | FIG. 1 |
| pattern | | | | | | | | |
| Groove width W3 at inner | 75 | 75 | 75 | 75 | 75 | 75 | 75 | 75 |
| end/maximum groove | | | | | | | | |
| width W2 (%) in first | | | | | | | | |
| shoulder lateral groove | | | | | | | | |
| Groove width W4 at first | 58 | 58 | 58 | 58 | 58 | 58 | 58 | 58 |
| tread end/maximum | | | | | | | | |
| groove width W2 (%) in | | | | | | | | |
| first shoulder lateral | | | | | | | | |
| groove | | | | | | | | |
| Groove width W7 at outer | 10 | 15 | 25 | 30 | 20 | 20 | 20 | 20 |
| end/maximum groove | | | | | | | | |
| width W2 (%) in first | | | | | | | | |
| shoulder lateral groove | | | | | | | | |
| Length L4 of inner | 20 | 20 | 20 | 20 | 10 | 15 | 25 | 30 |
| portion/width W5 of first | | | | | | | | |
| shoulder land portion (%) | | | | | | | | |
| Length L6 of outer | 80 | 80 | 80 | 80 | 80 | 80 | 80 | 80 |
| portion/width W5 of first | | | | | | | | |
| shoulder land portion (%) | | | | | | | | |
| Steering stability (score) | 108 | 107 | 106 | 105 | 105 | 106 | 107 | 107 |
| Wet performance (score) | 104 | 104 | 105 | 105 | 106 | 105 | 105 | 102 |

TABLE 3

| | Example 18 | Example 19 | Example 20 | Example 21 |
|---|---|---|---|---|
| Figure showing tread pattern | FIG. 1 | FIG. 1 | FIG. 1 | FIG. 1 |
| Groove width W3 at inner end/maximum groove | 75 | 75 | 75 | 75 |
| width W2 (%) in first shoulder lateral groove | | | | |
| Groove width W4 at first tread end/maximum groove | 58 | 58 | 58 | 58 |
| width W2 (%) in first shoulder lateral groove | | | | |
| Groove width W7 at outer end/maximum groove | 20 | 20 | 20 | 20 |
| width W2 (%) in first shoulder lateral groove | | | | |
| Length 1.4 of inner portion/width W5 of first | 20 | 20 | 20 | 20 |
| shoulder land portion (%) | | | | |
| Length 1.6 of outer portion/width W5 of first | 70 | 75 | 85 | 90 |
| shoulder land portion (%) | | | | |
| Steering stability (score) | 108 | 107 | 107 | 106 |
| Wet performance (score) | 104 | 105 | 105 | 106 |

According to Tables 1 to 3, it is understood that the tires of the examples had significantly enhanced steering stability and wet performance as compared with the comparative example. That is, it was confirmed that the tire according to the present disclosure had enhanced wet performance while maintaining steering stability on dry road surfaces.

### APPENDIX

The present disclosure includes the following aspects.

[Disclosure 1]

A tire including a tread portion, in which

the tread portion includes a plurality of circumferential grooves disposed between a first tread end and a second tread end so as to continuously extend in a tire circumferential direction, and a plurality of land portions demarcated by the plurality of circumferential grooves,

the plurality of circumferential grooves include a first shoulder circumferential groove disposed closest to the first tread end,

the plurality of land portions include a first shoulder land portion demarcated by the first shoulder circumferential groove, the first shoulder land portion including the first tread end,

the first shoulder land portion includes a plurality of first shoulder lateral grooves extending from the first shoulder circumferential groove to a position beyond the first tread end,

at least one of the first shoulder lateral grooves includes an inner end connected to the first shoulder circumferential groove, a maximum groove width portion at which the first shoulder lateral groove has a maximum groove width in a ground-contact surface of the first shoulder land portion, and an outer portion disposed outward of the first tread end in a tire axial direction,

a groove width at the inner end and a groove width, on the first tread end, of the first shoulder lateral groove are each less than the maximum groove width, and

a groove width of the outer portion is reduced outward in the tire axial direction.

[Disclosure 2]

In the tire according to disclosure 1,

the groove width of the inner end is 50% to 70% of the maximum groove width.

[Disclosure 3]

In the tire according to disclosure 1 or 2,

the first shoulder lateral groove includes an outer end in the tire axial direction, and

a groove width of the outer end is 10% to 30% of the maximum groove width.

[Disclosure 4]

In the tire according to any one of disclosures 1 to 3,

the outer portion includes a first portion, and a second portion disposed outward of the first portion in the tire axial direction,

a groove width of the first portion is reduced outward in the tire axial direction at a first reduction rate, and

a groove width of the second portion is reduced outward in the tire axial direction at a second reduction rate less than the first reduction rate.

[Disclosure 5]

In the tire according to disclosure 4,

the first shoulder lateral groove further includes an inner portion extending outward from the inner end in the tire axial direction with a uniform groove width, and

a length, in the tire axial direction, of the second portion is greater than a length, in the tire axial direction, of the inner portion.

[Disclosure 6]

In the tire according to disclosure 4 or 5,

a length, in the tire axial direction, of the second portion is less than a length, in the tire axial direction, of a portion of the first shoulder lateral groove excluding the second portion and an inner portion.

[Disclosure 7]

In the tire according to any one of disclosures 1 to 6,

the first shoulder lateral groove includes an edge on one side in the tire circumferential direction, and an edge on another side in the tire circumferential direction,

chamfered portions are connected to the edge on the one side and the edge on the other side, and

each chamfered portion includes an inclined surface extending diagonally from a corresponding one of the edges.

[Disclosure 8]

In the tire according to disclosure 7,

the chamfered portion connected to the edge on the one side extends from the inner end of the first shoulder lateral groove to a position preceding the first tread end.

[Disclosure 9]

In the tire according to disclosure 7 or 8,

the edge on the one side linearly extends from the inner end to the maximum groove width portion, and

the chamfered portion connected to the edge on the one side extends from the inner end to the maximum groove width portion with a uniform width.

[Disclosure 10]

In the tire according to any one of disclosures 7 to 9,

the first shoulder lateral groove further includes an inner portion extending outward from the inner end in the tire axial direction with a uniform groove width, and

the chamfered portion connected to the edge on the other side is disposed at least in the inner portion and the maximum groove width portion.

[Disclosure 11]

In the tire according to any one of disclosures 7 to 10,

the chamfered portion connected to the edge on the other side extends from the maximum groove width portion to a position beyond the first tread end.

[Disclosure 12]

In the tire according to any one of disclosures 1 to 11,

the first shoulder lateral groove includes a chamfered portion connected to an edge on one side of the first shoulder lateral groove, and

the chamfered portion extends from the inner end of the first shoulder lateral groove to a position preceding the first tread end.

[Disclosure 13]

In the tire according to any one of disclosures 1 to 12,

the first shoulder lateral groove includes an outer end opposite the inner end, and

the outer end is offset from the inner end in the tire circumferential direction and the tire axial direction.

[Disclosure 14]

In the tire according to any one of disclosures 1 to 13,

the first shoulder lateral groove includes a first edge portion on one side in the tire circumferential direction, and a second edge portion on the one side in the tire circumferential direction,

a circumferential edge is between the first edge portion and the second edge portion, and

the circumferential edge extends at a angle of 20 to 40 degrees with respect to the tire circumferential direction.

[Disclosure 15]

In the tire according to any one of disclosures 1 to 14,

groove width of the first shoulder lateral groove increases stepwise from an inner portion of the first shoulder lateral groove to the maximum groove width.

[Disclosure 16]

In the tire according to any one of disclosures 1 to 15,

the maximum groove width is offset from a center of the first shoulder lateral groove in the tire axil direction.

[Disclosure 17]

A tire tread portion, including:

a plurality of circumferential grooves between a first tread end and a second tread end so as to continuously extend in a tire circumferential direction, and

a plurality of land portions demarcated by the plurality of circumferential grooves, wherein

the plurality of circumferential grooves include a first shoulder circumferential groove disposed closest to the first tread end,

the plurality of land portions include a first shoulder land portion demarcated by the first shoulder circumferential groove, the first shoulder land portion including the first tread end,

the first shoulder land portion includes a plurality of first shoulder lateral grooves extending from the first shoulder circumferential groove to a position beyond the first tread end,

at least one of the first shoulder lateral grooves includes an inner end connected to the first shoulder circumferential groove, a maximum groove width portion at which the first shoulder lateral groove has a maximum groove width in a ground-contact surface of the first shoulder land portion, and an outer portion disposed outward of the first tread end in a tire axial direction,

a groove width at the inner end and a groove width, on the first tread end, of the first shoulder lateral groove are each less than the maximum groove width, and

a groove width of the outer portion of the first shoulder lateral groove is reduced outward in the tire axial direction.

[Disclosure 18]

In the tire tread portion according to disclosure 17,

the maximum groove width is offset from a center of the first shoulder lateral groove in the tire axil direction,

the first shoulder lateral groove includes an outer end opposite the inner end, and

the outer end is offset from the inner end in the tire circumferential direction and the tire axial direction.

[Disclosure 19]

In the tire tread portion according to any one of disclosures 17 to 18,

the first shoulder lateral groove includes a first edge on one side in the tire circumferential direction, and a second edge on another side in the tire circumferential direction,

chamfered portions are connected to the first edge on the one side and the second edge on the other side,

each chamfered portion includes an inclined surface extending diagonally from a corresponding one of the first or second edges, and

the chamfered portion connected to the first edge on the one side extends from the inner end of the first shoulder lateral groove to a position preceding the first tread end.

[Disclosure 20]

In the tire tread portion according to any one of disclosures 17 to 19,

groove width of the first shoulder lateral groove decreases at all times from the maximum groove width to an outer end of the first shoulder lateral groove opposite the inner end of the first shoulder lateral groove.

What is claimed is:

1. A tire comprising:
a tread portion, wherein
the tread portion includes a plurality of circumferential grooves disposed between a first tread end and a second tread end so as to continuously extend in a tire circumferential direction, and a plurality of land portions demarcated by the plurality of circumferential grooves,
the plurality of circumferential grooves include a first shoulder circumferential groove disposed closest to the first tread end,
the plurality of land portions include a first shoulder land portion demarcated by the first shoulder circumferential groove, the first shoulder land portion including the first tread end,
the first shoulder land portion includes a plurality of first shoulder lateral grooves extending from the first shoulder circumferential groove to a position beyond the first tread end,
at least one of the first shoulder lateral grooves includes an inner end connected to the first shoulder circumferential groove, a maximum groove width portion at which the first shoulder lateral groove has a maximum groove width in a ground-contact surface of the first shoulder land portion, and an outer portion disposed outward of the first tread end in a tire axial direction,
a groove width at the inner end and a groove width, on the first tread end, of the first shoulder lateral groove are each less than the maximum groove width, and
a groove width of the outer portion of the first shoulder lateral groove is reduced outward in the tire axial direction.

2. The tire according to claim 1, wherein
the groove width of the inner end is 50% to 70% of the maximum groove width.

3. The tire according to claim 1, wherein
the first shoulder lateral groove includes an outer end in the tire axial direction, and
a groove width of the outer end is 10% to 30% of the maximum groove width.

4. The tire according to claim 1, wherein
the outer portion includes a first portion, and a second portion outward of the first portion in the tire axial direction,
a groove width of the first portion is reduced outward in the tire axial direction at a first reduction rate, and
a groove width of the second portion is reduced outward in the tire axial direction at a second reduction rate less than the first reduction rate.

5. The tire according to claim 4, wherein
the first shoulder lateral groove further includes an inner portion extending outward from the inner end in the tire axial direction with a uniform groove width, and
a length, in the tire axial direction, of the second portion is greater than a length, in the tire axial direction, of the inner portion.

6. The tire according to claim 4, wherein
a length, in the tire axial direction, of the second portion is less than a length, in the tire axial direction, of a portion of the first shoulder lateral groove excluding the second portion and an inner portion.

7. The tire according to claim 1, wherein
the first shoulder lateral groove includes a first edge on one side in the tire circumferential direction, and second edge on another side in the tire circumferential direction,
chamfered portions are connected to the first edge on the one side and second the edge on the other side, and
each chamfered portion includes an inclined surface extending diagonally from a corresponding one of the first or second edges.

8. The tire according to claim 1, wherein
the first shoulder lateral groove includes a chamfered portion connected to an edge on one side of the first shoulder lateral groove, and
the chamfered portion extends from the inner end of the first shoulder lateral groove to a position preceding the first tread end.

9. The tire according to claim 7, wherein
the edge on the one side linearly extends from the inner end to the maximum groove width portion, and
the chamfered portion connected to the edge on the one side extends from the inner end to the maximum groove width portion with a uniform width.

10. The tire according to claim 7, wherein
the first shoulder lateral groove further includes an inner portion extending outward from the inner end in the tire axial direction with a uniform groove width, and
the chamfered portion connected to the edge on the other side is disposed at least in the inner portion and the maximum groove width portion.

11. The tire according to claim 7, wherein
the chamfered portion connected to the edge on the other side extends from the maximum groove width portion to a position beyond the first tread end.

12. The tire according to claim 1, wherein
the first shoulder lateral groove includes a first edge on one side in the tire circumferential direction, and a second edge on another side in the tire circumferential direction,
chamfered portions are connected to the first edge on the one side and the second edge on the other side,
each chamfered portion includes an inclined surface extending diagonally from a corresponding one of the first or second edges, and
the chamfered portion connected to the first edge on the one side extends from the inner end of the first shoulder lateral groove to a position preceding the first tread end.

13. The tire according to claim 1, wherein
the first shoulder lateral groove includes an outer end opposite the inner end, and
the outer end is offset from the inner end in the tire circumferential direction and the tire axial direction.

14. The tire according to claim 1, wherein
the first shoulder lateral groove includes a first edge portion on one side in the tire circumferential direction, and a second edge portion on the one side in the tire circumferential direction,
a circumferential edge is between the first edge portion and the second edge portion, and
the circumferential edge extends at a angle of 20 to 40 degrees with respect to the tire circumferential direction.

15. The tire according to claim 1, wherein
groove width of the first shoulder lateral groove increases stepwise from an inner portion of the first shoulder lateral groove to the maximum groove width.

16. The tire according to claim 1, wherein
the maximum groove width is offset from a center of the first shoulder lateral groove in the tire axil direction.

17. A tire tread portion, including:
a plurality of circumferential grooves between a first tread end and a second tread end so as to continuously extend in a tire circumferential direction, and
a plurality of land portions demarcated by the plurality of circumferential grooves, wherein
the plurality of circumferential grooves include a first shoulder circumferential groove disposed closest to the first tread end,
the plurality of land portions include a first shoulder land portion demarcated by the first shoulder circumferential groove, the first shoulder land portion including the first tread end,
the first shoulder land portion includes a plurality of first shoulder lateral grooves extending from the first shoulder circumferential groove to a position beyond the first tread end,
at least one of the first shoulder lateral grooves includes an inner end connected to the first shoulder circumferential groove, a maximum groove width portion at which the first shoulder lateral groove has a maximum groove width in a ground-contact surface of the first shoulder land portion, and an outer portion disposed outward of the first tread end in a tire axial direction,
a groove width at the inner end and a groove width, on the first tread end, of the first shoulder lateral groove are each less than the maximum groove width, and
a groove width of the outer portion of the first shoulder lateral groove is reduced outward in the tire axial direction.

18. The tire tread portion according to claim 17, wherein
the maximum groove width is offset from a center of the first shoulder lateral groove in the tire axil direction,
the first shoulder lateral groove includes an outer end opposite the inner end, and
the outer end is offset from the inner end in the tire circumferential direction and the tire axial direction.

19. The tire tread portion according to claim 17, wherein
the first shoulder lateral groove includes a first edge on one side in the tire circumferential direction, and a second edge on another side in the tire circumferential direction,
chamfered portions are connected to the first edge on the one side and the second edge on the other side,
each chamfered portion includes an inclined surface extending diagonally from a corresponding one of the first or second edges, and
the chamfered portion connected to the first edge on the one side extends from the inner end of the first shoulder lateral groove to a position preceding the first tread end.

20. The tire tread portion according to claim 17, wherein
groove width of the first shoulder lateral groove decreases at all times from the maximum groove width to an outer end of the first shoulder lateral groove opposite the inner end of the first shoulder lateral groove.
